(19) United States
(12) Patent Application Publication
(10) Pub. No.: US 2011/0293980 A1
(43) Pub. Date: Dec. 1, 2011

(54) BATTERY CUSHION AND INSULATOR

(76) Inventor: Steven Tartaglia, Safety Harbor, FL (US)

(21) Appl. No.: 12/786,473

(22) Filed: May 25, 2010

(51) Int. Cl. H01M 2/10

(52) U.S. Cl. 429/100

(57) ABSTRACT

An application for a battery shield including a set of walls made of a resilient, elastomeric material and a base made of the same resilient, elastomeric material. A bottom edge of the walls connects to an edge of the base forming a rectangular cavity having a width and a depth. The width is substantially equivalent to the width of a battery pack and the depth is substantially equivalent to the depth of the battery pack, thereby the battery shield snuggly fits around the battery pack, reducing shock and vibration of the battery pack from external shock and vibration and insulating the battery pack from ambient temperature extremes.

### FIELD

This invention relates to the field of batteries and more particularly to a system for insulating, protecting and absorbing shocks related to battery packs.

### BACKGROUND

Battery packs such as flooded lead-acid, absorbed-glass-matt (AGM) and lead-acid perform best at certain temperature ranges and are susceptible to extreme shock and vibration often found in applications such as aviation, automotive, space and other transportation applications. External heat or cold often interact with internally generated heat causing reduced capacity and or failure of one or more cells of the battery pack. Many battery pack chemistries are not tolerant of shock and vibration, also leading to damaged cells or cell structures, resulting in reduced output power and/or total failure of one or more cells.

What is needed is a system that will reduce external temperature effects on the battery packs while also reducing shock and vibration exerted on the battery pack from the battery pack's environment.

### SUMMARY

A battery shield is disclosed including a set of walls made of a resilient, elastomeric material and a base made of the same resilient, elastomeric material. A bottom edge of the walls connects to an edge of the base forming a rectangular cavity having a width and a depth. The width is substantially equivalent to the width of a battery pack and the depth is substantially equivalent to the depth of the battery pack, thereby the battery shield snuggly fits around the battery pack, reducing shock and vibration of the battery pack from external shock and vibration and insulating the battery pack from ambient temperature extremes.

In another embodiment, a battery shield is disclosed including a resilient, elastomeric material formed into a set of walls and a base such that a bottom edge of the walls interfaces to an edge of the base, thereby forming a rectangular cavity. The rectangular cavity has a width and a depth that are substantially equivalent to a width and a depth of a battery pack, respectively, thereby the battery shield snuggly fits around the battery pack, reducing shock and vibration of the battery pack from external shock and vibration and insulating the battery pack from ambient temperature extremes.

In another embodiment, a battery shield system is disclosed including a set of walls made of a resilient, elastomeric material and a base also made of the resilient, elastomeric material. Bottom edges of the walls are connected to an edge of the base, thereby forming a rectangular cavity. A battery pack is held between the walls and rests on the base and, therefore, the battery pack is insulated from ambient temperature extremes by the walls and the base and the walls and the base dampen at least some external shock and vibration from reaching the battery pack.

### BRIEF DESCRIPTION OF THE DRAWINGS

The invention can be best understood by those having ordinary skill in the art by reference to the following detailed description when considered in conjunction with the accompanying drawings in which:

FIG. 1 illustrates a perspective view of a typical battery pack installed within a battery shield.

FIG. 2 illustrates a perspective view of a typical battery pack being inserted into a battery shield.

FIG. 3 illustrates a bottom plan view of a battery shield.

FIG. 4 illustrates a side sectional view of a battery shield.

FIG. 5 illustrates a perspective view of a typical battery pack held within a battery shield.

FIG. 6 illustrates a perspective view of a typical battery pack being inserted into a second battery shield.

FIG. 7 illustrates a top plan view of the second battery shield.

FIG. 8 illustrates a side sectional view of the second battery shield.

### DETAILED DESCRIPTION

Reference will now be made in detail to the presently preferred embodiments of the invention, examples of which are illustrated in the accompanying drawings. Throughout the following detailed description, the same reference numerals refer to the same elements in all figures.

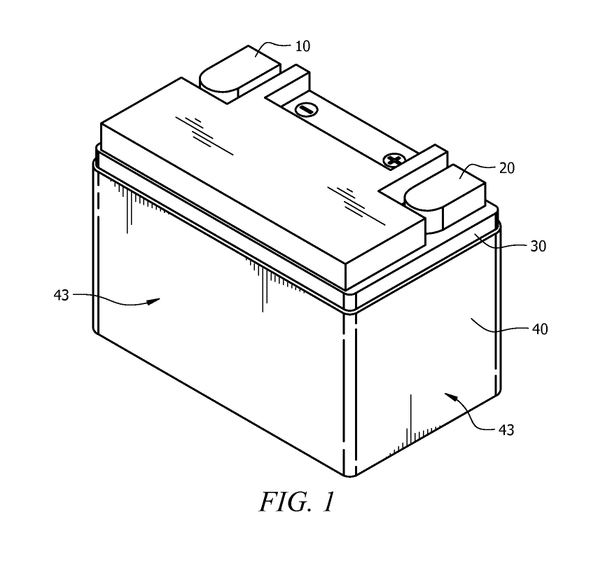

Referring to FIG. 1, a perspective view of a typical battery pack 30 installed within a battery shield 40 is shown. Many batteries 30 such as lead-based (e.g. flooded lead-acid, absorbed-glass-matt, lead-acid and lead-acid derivatives) have a positive 10 and negative 20 battery terminal for delivering power to applications and accepting charge current. Many or most batteries 30 are sensitive to temperature and vibration and are often used in harsh environments having high amounts of vibration and extreme ambient temperatures. For example, a battery 30 used in automotive applications often are exposed to random vibration from uneven road surfaces and cyclic vibration from the vehicle engines. Such batteries are often subject to extremely cold outdoor temperatures and very high temperatures from ambient impacted by heat from the engine. Similarly, a battery 30 used in aeronautic applications is often exposed to similar vibration such as random vibration from uneven runway surfaces or air turbulence and cyclic vibration from the airplane engines. These batteries are also subject to extremely cold high-altitude temperatures and very high temperatures from ambient impacted by heat from the engine and other electronics.

To reduce the vibration and temperature exposure, the battery 30 is placed into a battery shield 40 made of an insulative, resilient elastomeric material that provides isolation from ambient temperature extremes, shock and vibration. Many different materials are anticipated including rubber, rubber derivatives, foams, thermoplastic-elastomeric, thermoplastic-urethane etc. Such material must be sturdy so as not to prematurely fail due to excessive heat and constant vibration. These materials partially insulate the battery 30 from the ambient air temperature and also dampen shock and vibration, reducing shock and vibration damage to the battery back 30.

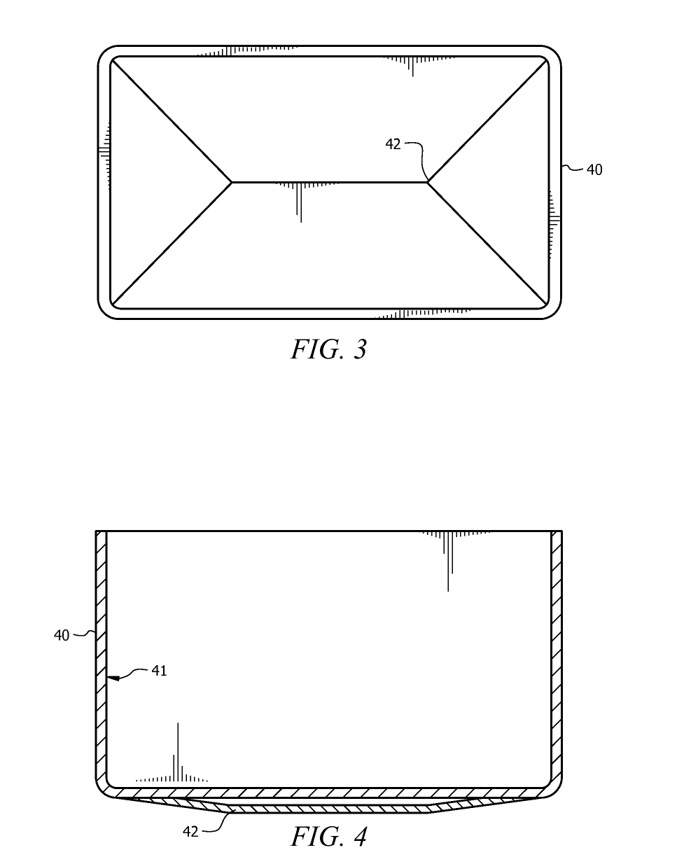

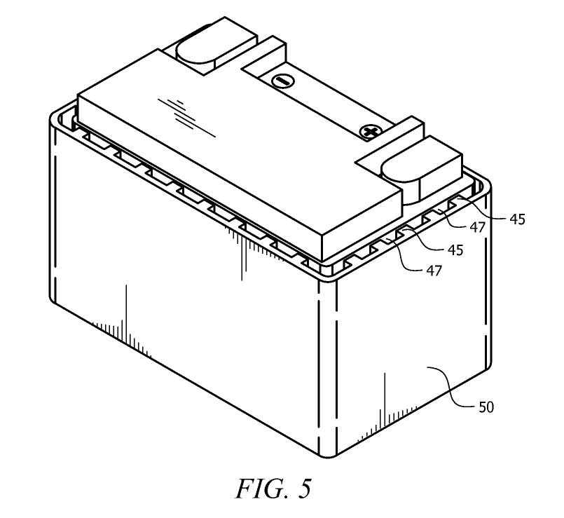

It is anticipated that the thickness of the walls 43 and base 42 (see FIGS. 3 and 4), ribbing (see FIGS. 5-8) and material composition of the battery shield 40 are selected to optimize dampening of a specific frequency range of vibration. For example, in an automotive application in which the peak vibration is at 1000 Hz, the thickness, material and construction are selected to optimally dampen that frequency.

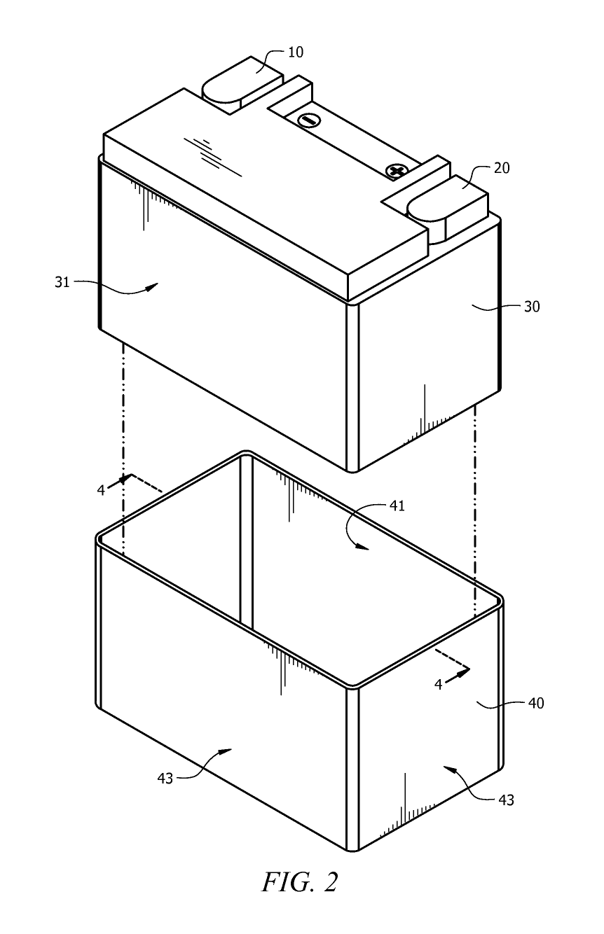

Referring to FIG. 2, a perspective view of a typical battery pack 30 being inserted into a battery shield 40 is shown. For improved protection, it is preferred, though not required, that the width of the battery shield 40 be similar to the width of the battery pack 30 and the length of the battery shield 40 be similar to the length of the battery pack 30. Although this is not required, by making the inner dimensions of the battery shield 40 similar to the outer dimensions of the battery 30, a tight fit is provided, limiting movement of the battery pack 30 within the battery shield 40. In such, the outer walls 31 of the battery 30 substantially contact the inner walls 41 of the battery shield 40.

The battery shield 40 is made of any shape to conform to the shape of the battery pack 30. The battery shield 40 has walls 43 and a base 42 (see FIGS. 3 and 4). Although it is preferred that the battery shield 40 be formed as a monolithic device, it is anticipated that, in some embodiments, the base 42 is fabricated separately and an outer edge of the base 42 is affixed to the bottom edge of the walls 43 by ways known in the industry such as using adhesives, ultrasonic welding, etc.

The battery 30 is insulated from ambient temperature extremes by the battery shield 40. Since the battery shield 40 is made of a material such as rubber that at least partially insulates the battery 30 from ambient temperatures, the battery 30 is less effected by, for example, engine compartment heat. Since the battery shield 40 is made of a soft, malleable material such as rubber, shock and vibration from the environment is dampened, increasing the life of the battery 30.

Referring to FIG. 3, a bottom plan view of a battery shield 40 is shown. In this view, the bottom thickness 42 of the battery shield 40 is greater than that of the thickness of the walls 43. Since, is typical or most battery 30 installations, the battery is installed with the terminals 10/20 facing upward, most of the mass of the battery 30 rests on the bottom surfaces 42 of the battery 30. The increased bottom thickness of the base 42 provides a thicker cushion of material between the bottom surface of the battery 30 and the holder or base to which the battery 30 rests. This increases the amount of vibration and shock dampening.

Referring to FIG. 4, a side sectional view of a battery shield is shown. In this view as well, the optional increased bottom thickness 42 of the battery shield 40 is visible. Since, is typical or most battery 30 installations, the battery is installed with the terminals 10/20 facing upward, most of the mass of the battery 30 rests on the bottom surfaces of the battery 30. The increased bottom thickness 42 provides a thicker cushion of material between the bottom surface of the battery 30 and the holder or base to which the battery 30 rests. This improves the amount of vibration and shock dampening.

Referring to FIG. 5, a perspective view of a typical battery pack 30 held within a second battery shield 50 is shown. This battery shield has ribs 45 that both increase the wall thickness of the battery shield 50 and increase the insulation due to air gaps 47, being that air doesn't conduct heat as well as many other materials. The increased thickness from the ribs 45 as well as having two different material densities (one towards the outer surface of the battery shield 50 and the other at the ribs 45) further improves on the battery shields' 50 dampening properties. For example, the ribs 45 dampen on frequency of vibration while the solid outer surface of the shield 50 dampens a second frequency of vibration. Any configuration of ribs 45 is anticipated including irregular width ribs 45 and ribs 45 of varying geometries (rectangular or square geometries are shown in FIG. 5).

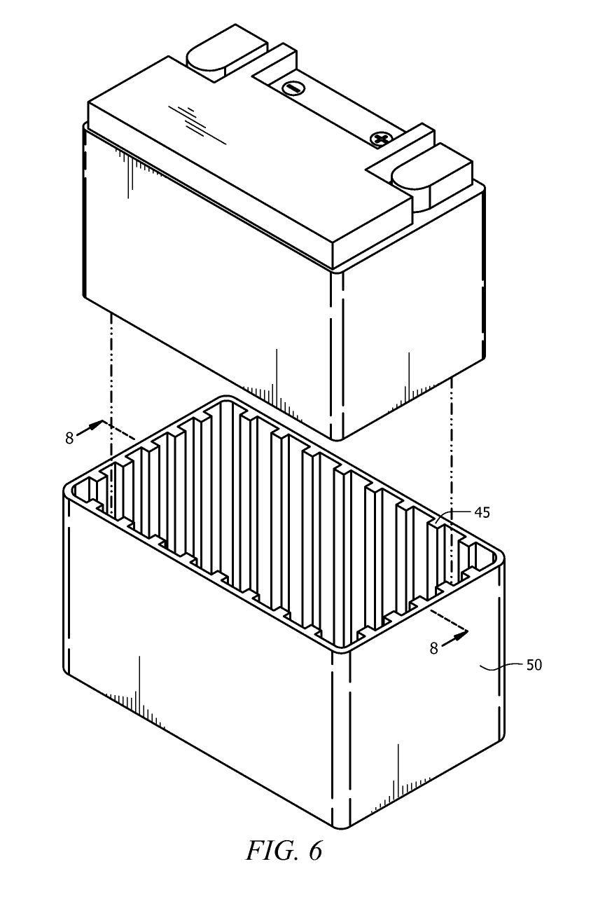

Referring to FIG. 6, a perspective view of a typical battery pack 30 being inserted into a second battery shield 50 is shown. Although not required, it is anticipated that the inner dimensions of the battery shield ribs 45 are similar to the outer dimensions of the battery 30, thereby providing a tight fit. In such, the outer surfaces of the battery 30 substantially contact the inner surfaces of the battery shield ribs 45. The battery 30 is insulated from ambient temperature extremes by the battery shield 50 with ribs 45 (and air gaps 47). Since the battery shield 50 is made of a material such as rubber that at least partially insulates the battery 30 from ambient temperature extremes, the battery 30 is less effected by, for example, engine compartment heat. Since the battery shield 50 is made of a soft, malleable material such as rubber, shock and vibration from the environment is dampened, increasing the life of the battery 30.

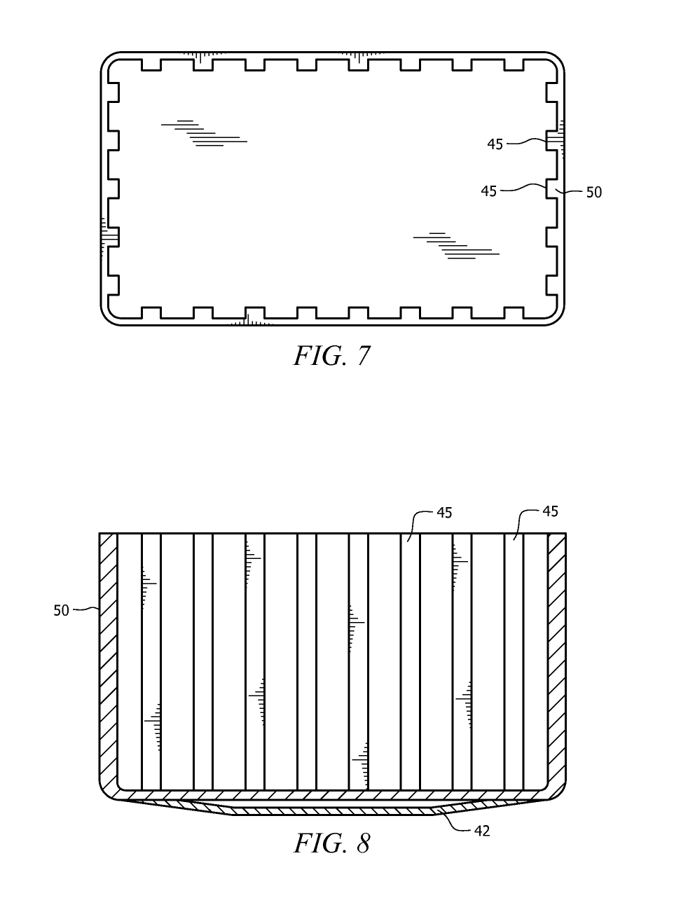

Referring to FIG. 7, a top plan view of the second battery shield 50 is shown. Although the ribs 45 are shown as having a general rectangular shape, any shape is anticipated. For example, in another embodiment, the ribs 45 are of semi-circular cross-section, etc.

Referring to FIG. 8, a side sectional view of the second battery shield 50 is shown. In this view, it is shown that the ribs 45 are vertical along the inside surfaces of the battery shield 50. It is anticipated that, in other embodiments, the ribs 45 are at any other orientation and/or the ribs 45 are on any inner surface of the battery shield 50. Furthermore, it is anticipated that, in some embodiments, the ribs 45 vary directions, intersect each other, are shorter in length, etc. In the embodiment of FIG. 8, the base 42 is shown thicker, providing increased cushioning and, hence, dampening of shock and vibration.

Equivalent elements can be substituted for the ones set forth above such that they perform in substantially the same manner in substantially the same way for achieving substantially the same result.

It is believed that the system and method as described and many of its attendant advantages will be understood by the foregoing description. It is also believed that it will be apparent that various changes may be made in the form, construction and arrangement of the components thereof without departing from the scope and spirit of the invention or without sacrificing all of its material advantages. The form herein before described being merely exemplary and explanatory embodiment thereof. It is the intention of the following claims to encompass and include such changes.

What is claimed is:

1. A battery shield comprising:
a set of walls made of a resilient, elastomeric material; and
a base made of the resilient, elastomeric material, a bottom edge of the walls connected to an edge of the base forming a rectangular cavity having a width and a depth, the width being substantially equivalent to a battery pack width and the depth being substantially equivalent to a battery pack depth, thereby the battery shield snuggly fitting around the battery pack, reducing shock and vibration of the battery pack from external shock and vibration and insulating the battery pack from ambient temperature extremes.

2. The battery shield of claim 1, wherein the resilient, elastomeric material is rubber.

3. The battery shield of claim 1, wherein the resilient, elastomeric material is thermoplastic-elastomeric.

4. The battery shield of claim 1, wherein the resilient, elastomeric material is thermoplastic-urethane.

5. The battery shield of claim 1, further comprising a plurality of ribs on an inside surface of the walls.

6. The battery shield of claim 5, further comprising a plurality of ribs on an inside surface of the base.

7. The battery shield of claim 1, wherein the thickness of the walls, the thickness of the base and the resilient, elastomeric material are selected to dampen a particular frequency of vibration.

8. A battery shield comprising:
a resilient, elastomeric material formed into a set of walls and a base such that a bottom edge of the walls interfaces to an edge of the base forming a rectangular cavity, the rectangular cavity having a width and a depth that are substantially equivalent to a width of a battery pack and a depth of a battery pack, respectively, thereby the battery shield snuggly fits around the battery pack, reducing shock and vibration of the battery pack from external shock and vibration and insulating the battery pack from ambient temperature extremes.

9. The battery shield of claim 8, wherein the resilient, elastomeric material is rubber.

10. The battery shield of claim 8, wherein the resilient, elastomeric material is thermoplastic-elastomeric.

11. The battery shield of claim 8, wherein the resilient, elastomeric material is thermoplastic-urethane.

12. The battery shield of claim 8, further comprising a plurality of ribs on an inside surface of the walls.

13. The battery shield of claim 12, further comprising a plurality of ribs on an inside surface of the base.

14. The battery shield of claim 8, wherein the thickness of the walls, the thickness of the base and the resilient, elastomeric material are selected to dampen a particular frequency of vibration.

15. The battery shield of claim 8, wherein the thickness of the base is greater than the thickness of the walls.

16. A battery shield system comprising:
a set of walls made of a resilient, elastomeric material;
a base made of the resilient, elastomeric material, a bottom edge of the walls connected to an edge of the base forming a rectangular cavity; and
a battery pack held between the walls and resting on the base, the battery pack insulated from ambient temperature extremes by the walls and the base and the walls and the base dampening at least some external shock and vibration from reaching the battery pack.

17. The battery shield of claim 16, wherein the resilient, elastomeric material is rubber.

18. The battery shield of claim 16, wherein the resilient, elastomeric material is thermoplastic-elastomeric.

19. The battery shield of claim 16, wherein the resilient, elastomeric material is thermoplastic-urethane.

20. The battery shield of claim 16, further comprising a plurality of ribs on an inside surface of the walls.
